(19) United States
(12) Patent Application Publication
(10) Pub. No.: US 2019/0153164 A1
(43) Pub. Date: May 23, 2019

(54) CURABLE SEALANT COMPOSITION

(71) Applicant: BASF SE, Ludwigshafen am Rhein (DE)

(72) Inventors: John Michael Davis, Eden Prairie, MN (US); Rajesh Kumar, Riverview, MI (US); Ralph Dieter Maier, Ann Arbor, MI (US); Karl Matos, Sewickley, PA (US); Kevin M. Neigh, Butler, PA (US); Kristin Schroeder, Princeton, NJ (US)

(21) Appl. No.: 16/091,396

(22) PCT Filed: Apr. 7, 2017
(86) PCT No.: PCT/US2017/026513

§ 371 Date: Oct. 4, 2018

Related U.S. Application Data
(60) Provisional application No. 62/319,574, filed on Apr. 7, 2016.

(51) Int. Cl. C08G 75/045; C09K 3/10; C09J 181/02

(52) U.S. Cl. CPC C08G 75/045; C09K 3/1012; C08G 2190/00; C08G 2170/00; C09J 181/02

(57) ABSTRACT

A curable sealant composition includes a polysulfide having an —SH group, a compound having at least one carbon-carbon double bond, and an alkylborane amine catalyst. A cured sealant is formed from the curable sealant composition, wherein the cured sealant includes the polymerization product of the polysulfide and the compound having the at least one carbon-carbon double bond reacted in the presence of the alkylborane amine catalyst. Furthermore, a curable sealant system includes a first component including the polysulfide and the alkylborane amine catalyst and a second component including the compound having the at least one carbon-carbon double bond. Moreover, an article includes a substrate and the cured sealant disposed on the substrate. The curable sealant composition is formed using a method including the steps of providing and combining the polysulfide, the alkylborane amine catalyst, and the compound having the at least one carbon-carbon double bond, to form the curable composition.

### FIELD OF THE DISCLOSURE

This disclosure generally relates to a curable sealant composition. More specifically, this disclosure relates to a sealant composition that includes a polysulfide having an —SH group, a compound having at least one carbon-carbon double bond, and an alkylborane amine catalyst.

### BACKGROUND

Polysulfide compositions in liquid and curable form are known in the art and have been used in a variety of industries. Typically, polysulfides are cured by an oxidoreduction reaction wherein manganese dioxide is used to cure the polysulfides over a number of days. However, this long curing time increases production times and costs and reduces efficiency.

The use of sealants in the manufacture or maintenance of aircraft has previously been a very complex process. The reason for this is the numerous joints having sealants, where sealants that often have very long processing times of 12 to 60 hours must be used. These methods typically require an extremely long time for complete curing and have required a very long tack-free time in the past in proportion to the length of the processing time. For example, an interlayer sealant of class C for the aviation field typically takes 60 to 70 days to achieve a Shore A hardness of 30 if the processing time is 60 hours. Furthermore, conventional type A and B sealants, which are usually applied over a surface or in the form of a bead for coating bolts, rivets or other structural elements typically need 2 to 5 hours to become tack-free if the processing time is 30 minutes, and typically greater than 24 hours to achieve a Shore A hardness of 30. Therefore, there remains an opportunity for improvement.

### SUMMARY OF THE DISCLOSURE

This disclosure provides a curable sealant composition that includes a polysulfide having an —SH group, a compound having at least one carbon-carbon double bond, and an alkylborane amine catalyst. Moreover, this disclosure provides a cured sealant formed from the curable sealant composition, wherein the cured sealant includes the polymerization product of the polysulfide and the compound having the at least one carbon-carbon double bond reacted in the presence of the alkylborane amine catalyst. This disclosure also provides a curable sealant system including a first component including the polysulfide and the alkylborane amine catalyst and a second component including the compound having the at least one carbon-carbon double bond. This disclosure also provides an article including a substrate and the cured sealant disposed on the substrate. This disclosure also provides a method of forming the curable sealant composition wherein the method includes the steps of providing the polysulfide, the alkylborane amine catalyst, and the compound having the at least one carbon-carbon double bond, and combining the polysulfide, the alkylborane amine catalyst, and the compound having the at least one carbon-carbon double bond to form the curable composition. This disclosure further provides a method of forming the cured sealant wherein the method includes the steps of providing the polysulfide, the alkylborane amine catalyst, and the compound having the at least one carbon-carbon double bond and combining the polysulfide, the alkylborane amine catalyst, and the compound having the at least one carbon-carbon double bond such that the polysulfide polymerizes with the compound having the at least one carbon-carbon double bond in the presence of the alkylborane amine catalyst to form the cured sealant. Even further, this disclosure provides a method of forming the article wherein the method includes the steps of providing the polysulfide, the alkylborane amine catalyst, and the compound having the at least one carbon-carbon double bond and applying the polysulfide, the alkylborane amine catalyst, and the compound having the at least one carbon-carbon double bond onto the substrate such that the polysulfide polymerizes with the compound having the at least one carbon-carbon double bond in the presence of the alkylborane amine catalyst and forms the cured sealant disposed on the substrate.

### DETAILED DESCRIPTION OF THE DISCLOSURE

This disclosure provides a curable sealant composition (hereinafter described as the “composition.”). The composition is curable and may be cured. After cure, the composition may be described as a cured sealant composition or simply as the cured composition. This disclosure describes an uncured composition, a partially cured composition, and a completely or fully cured composition. Accordingly, below, the terminology “composition” may describe any of the aforementioned types of compositions unless otherwise particularly stated.

The composition is not particularly limited and may be used in any industry, for example, in aeronautics, construction, for constructing and/or maintaining aircraft or spacecraft, in motor vehicles, in rail vehicles, in ships, in machines, in appliances and furniture, and, more particularly, for adhesive bonding and/or protection against corrosion of aircraft or spacecraft, motor vehicles, rail vehicles, ships, machines, appliances and furniture. In one embodiment, the composition is used as a sealant in an aircraft. In another embodiment, the composition is used as a sealant on a fuel-tank of an aircraft. In still another embodiment, the composition is used as a sealant on a fuel-tank of a vehicle such as a train, automobile, etc.

The composition includes a polysulfide having an —SH group, an alkylborane amine catalyst, and compound having at least one carbon-carbon double bond. Each of these is described in detail below.

polysulfide:

The composition includes a polysulfide but may include two or more polysulfides or combinations of polysulfides, any one or more of which may be described below. For example, the composition may include at least one polysulfide, at least two polysulfides, etc. In various non-limiting embodiments described herein, the terminology “polysulfide” may include two or more polysulfides. The terminology “polysulfide” typically describes (one or more) polysulfide (homo)polymer(s). However, it is contemplated that (one or more) polysulfide (co)polymer(s) may also be used, either alone or in combination with the (one or more) (homo)polymers.

The polysulfide has an —SH group but otherwise is not particularly limited and may be any in the art. For example, the polysulfide may have a single —SH group or two or more —SH groups. One or more or all of the groups may be terminal or pendant. In various embodiments, the polysulfide is described as part of a class of chemical compounds including chains of sulfur atoms. In another embodiment, the polysulfide is a polymer having at least one S—S bond in its chain and an —SH group. The polysulfide of this disclosure is typically described as an organic polysulfide (as opposed to a sulfide anion (Sₐ²⁻). In one embodiment, the polysulfide of this disclosure has the formula RSₐR(—SH)_{b}, wherein (a) is a number of 2 or greater, each R is independently an alkyl or aryl group, each —SH group is terminal or pendant, and (b) is a number of 1 or greater.

In other embodiments, the polysulfide is further defined as including a plurality of blocks each having the formula wherein x is from 1 to 5 and R¹ is an alkyl group having 2 to 16 carbon atoms or an alkyl group 16 carbon atoms that further comprises one or more ether groups, and further having a terminal thiol group having the formula —R²—SH, wherein R² is an alkyl group having 2 to 16 carbon atoms or an alkyl group having 2 to 16 carbon atoms that further comprises an ether-bond.

In still other embodiments, the polysulfide has the formula —R³-[—S—(CH₂)₂—O—[-R⁴—O—]ₘ-(CH₂)₂—S—R³—]ₙ-. In this formula, each R³ is independently a C₂-C₆ n-alkylene group, a C₃-C₆ branched alkylene group, a C₆-C₈ cycloalkylene group, a C₆-C₁₀ alkylcycloalkylene group, or -[(—CH₂—)ₚ-X—]_{q}+CH₂—)ᵣ, or —[(—CH₂—)ₚ-X-]_{q}—CH₂-)ᵣ in which at least one CH₂ unit is substitute with a methyl group. Moreover, m is a number from 0 to 10, e.g. 1, 2, 3, 4, 5, 6, 7, 8, 9, or 10, n is a number from 1 to 60, e.g. 5 to 55, 10 to 50, 15 to 45, 20 to 40, 25 to 35; p is a number from 2 to 6, e.g. 2, 3, 4, 5, or 6; q is a number from 1 to 5, e.g. 1, 2, 3, 4, or 5, and r is a number from 2 to 10. e.g. 2, 3, 4, 5, 6, 7, 8, 9, or 10. In various non-limiting embodiments, all values and ranges of values between the aforementioned values are hereby expressly contemplated.

In further embodiments, the polysulfide has the formula:

HS—(C₂H₄—O—CH₂—O—C₂H₄—(S—S)₂₋₈)ₓ—C₂H₄—O—CH₂—O—C₂H₄—SH

wherein x is from 1 to 200, e.g. 5 to 195, 10 to 190, 15 to 185, 20 to 180, 25 to 175, 30 to 170, 35 to 165, 40 to 160, 45 to 155, 50 to 150, 55 to 145, 60 to 140, 65 to 135, 70 to 130, 75 to 125, 80 to 120, 85 to 115, 90 to 110, 95 to 105, or 95 to 100. In various non-limiting embodiments, all values and ranges of values between the aforementioned values are hereby expressly contemplated.

In further embodiments, the polysulfide has the formula:

H(S—C₂H₄—O—CH₂—O—C₂H₄—S)_{z}H

wherein z is from 7 to 43, e.g. 10 to 40, 15 to 35, 20 to 30, or 20 to 25.

In further embodiments, the polysulfide has the formula: HS—(R—SS)ₜ—R—SH, wherein each R is independently a C₂-C₆ n-alkylene group, a C₃-C₆ branched alkylene group, a C₆-C₈ cycloalkylene group, or a C₆-C₁₀ alkylcycloalkylene group and wherein t is from 5 to 40, e.g. 10 to 35, 15 to 30, 20 to 30, or 25 to 30. In various non-limiting embodiments, all values and ranges of values between the aforementioned values are hereby expressly contemplated.

In further embodiments, the polysulfide has the formula: HS—(R—SS)_{q}—CH₂CH((SS—R)ᵥ—SH)—CH₂—(SS—R)ᵣ—SH, wherein each R is independently a C₂-C₆ n-alkylene group, a C₃-C₆ branched alkylene group, a C₆-C₈ cycloalkylene group, or a C₆-C₁₀ alkylcycloalkylene group, wherein q+v+r is from 5 to 40, e.g. 10 to 35, 15 to 30, 20 to 30, or 25 to 30. In various non-limiting embodiments, all values and ranges of values between the aforementioned values are hereby expressly contemplated.

In further embodiments, the polysulfide has the formula:

HS—R—(O—CH₂—CH₂—S—CH₂—CH₂—O—CH₂—CH₂—S—CH₂—O—CH₂—CH₂—S—CH₂—CH₂—)-R—SH,

wherein each R is independently as described above.

In still other embodiment the polysulfide may be described as a long-chain polymer with a weight average molecular weight of 2800 to 9000 g/mol, e.g. those of Thioplast G131 or with a weight average molecular weight of 3300 to 5000 g/mol such as Thioplast G10, Thioplast G12, Thioplast G1, Thiokol LP 32, and/or Thiokol LP 12. In various non-limiting embodiments, all values and ranges of values between the aforementioned values are hereby expressly contemplated.

Alternatively, the polysulfide may be described as a short-chain polymer with a weight average molecular weight of 100 to 3200 g/mol, e.g. from 400 to 2800 g/mol and/or from 500 to 1200 g/mol, such as, for example, Thiokol LP3, Thioplast G4, Thioplast G22 or Thioplast G44.

In other embodiments, both long-chain polymers with a weight average molecular weight of 2800 to 9000 g/mol or 3300 to 5000 g/mol and short-chain polymers with a weight average molecular weight of 400 to 2800 g/mol or from 500 to 1200 g/mol, are used, e.g. in a weight ratio of 25:1 to 0.5:1, from 10:1 to 1:1 or from 6:1 to 2:1. In various non-limiting embodiments, all values and ranges of values between the aforementioned values are hereby expressly contemplated.

In still other embodiments, the polysulfide is described as a liquid polymer having a weight average molecular weight of from 100 to 7500 g/mol or from 500 to 6000 g/mol or from 1000 to 3000 g/mol. Alternatively, the polysulfide may have a weight average molecular weight of from 1,000 to 7,500, from 1,500 to 6,000, from 2,000 to 5,500, from 2,500 to 5,000, from 3,000 to 4,500, or from 3,500 to 4,000, g/mol. In various non-limiting embodiments, all values and ranges of values between the aforementioned values are hereby expressly contemplated.

In further embodiments, the polysulfide has a total sulfur content of from 1 to 50 wt %, 2 to 45 wt % or 10 to 38 wt %. In other embodiments, the polysulfide has an average functionality of —SH groups of greater than 2, greater than or equal to 2, 2, less than 2, or less than or equal to 2, e.g. from 1.5 to 2.5 or 1.9 to 2.2. In various embodiment, the average functionality is from 1.5 to 2 or 0.8 to 1.5. In other embodiments, the polysulfide has an average glass transition temperature Tg of from −80 to −30° C. or −60 to −40° C., measured according to AITM 1-0003 Airbus Industry Test Method of June 1995. In various non-limiting embodiments, all values and ranges of values between the aforementioned values are hereby expressly contemplated.

The amount of the polysulfide in the composition is not particularly limited. In various embodiments, the polysulfide is present in the composition in an amount of from 1 to 80, from 1 to 30, from 5 to 30, from 5 to 80, or from 30 to 80, parts by weight per 100 parts by weight of the composition. In various non-limiting embodiments, all values and ranges of values between the aforementioned values are hereby expressly contemplated.

### Compound Having at Least One Carbon-Carbon Double Bond:

The compound having at least one C═C double bond may be represented by the general formula:

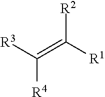

wherein R¹, R², R³, and R⁴ are each independently any alkyl group having 1 to 20 carbon atoms, e.g. any described in this disclosure. For example, the alkyl group may have 1, 2, 3, 4, 5, 6, 7, 8, 9, 10, 11, 12, 13, 14, 15, 16, 17, 18, 19, or 20, carbon atoms or any range thereof.

In various embodiments the compound having at least one C═C double bond may be represented by the general formula:

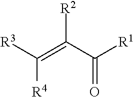

wherein R¹, R², R³, and R⁴ are each independently any alkyl group having 1 to 20 carbon atoms, e.g. any described in this disclosure. For example, the alkyl group may have 1, 2, 3, 4, 5, 6, 7, 8, 9, 10, 11, 12, 13, 14, 15, 16, 17, 18, 19, or 20, carbon atoms or any range thereof.

In various embodiments the compound having at least one C═C double bond may be represented by the general formula:

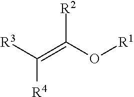

wherein R1, R2, R3, and R4 are each independently any alkyl group having 1 to 20 carbon atoms, e.g. any described in this disclosure. For example, the alkyl group may have 1, 2, 3, 4, 5, 6, 7, 8, 9, 10, 11, 12, 13, 14, 15, 16, 17, 18, 19, or 20, carbon atoms or any range thereof.

In various embodiments the compound having at least one C═C double may be represented by the general formula:

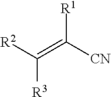

wherein R1, R2, R3, and R4 are each independently any alkyl group having 1 to 20 carbon atoms, e.g. any described in this disclosure. For example, the alkyl group may have 1, 2, 3, 4, 5, 6, 7, 8, 9, 10, 11, 12, 13, 14, 15, 16, 17, 18, 19, or 20, carbon atoms or any range thereof.

The compound having at least one C═C bond may be chosen from acrylates, halogen substituted acrylates, alkenoates, and combinations thereof. Acrylates may have the general formula:

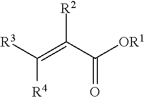

wherein R¹, R², R³, and R⁴ are each independently any alkyl group having 1 to 20 carbon atoms, e.g. any described in this disclosure. For example, the alkyl group may have 1, 2, 3, 4, 5, 6, 7, 8, 9, 10, 11, 12, 13, 14, 15, 16, 17, 18, 19, or 20, carbon atoms or any range thereof.

Suitable examples of acrylates include, but are not limited to, butyleneglycol diacrylate, butylene glycol dimethylacrylate, 2-ethylhexylacrylate, 2-ethylhexylmethacrylate, 2-hydroxyethylacrylate, 2 hydroxyethyl methacrylate, methylacrylate, methylmethacrylate, neopentylglycol diacrylate, neopentylglycoldimethacrylate, glycidyl acrylate, glycidyl methacrylate, allyl acrylate, allyl methacrylate, stearyl acrylate, stearyl methacrylate, tetrahydrofurfuryl acrylate, tetrahydrofurfuryl methacrylate, caprolactone acrylate, perfluorobutyl acrylate, perfluorobutyl methacrylate, 1H, 1H, 2H, 2H-heptadecafluorodecyl acrylate, 1H, 1H, 2H, 2H-heptadecafluorodecyl methacrylate, tetrahydroperfluoroacrylate, phenoxyethyl acrylate, phenoxyethyl methacrylate, bisphenol A acrylate, bisphenol A dimethacrylate, ethoxylated bisphenol A acrylate, ethoxylated bisphenol A methacrylate, hexafluoro bisphenol A diacrylate, hexafluoro bisphenol A dimethacrylate, diethyleneglycol diacrylate, diethyleneglycol dimethacrylate, dipropyleneglycol diacrylate, dipropyleneglycol dimethacrylate, polyethyleneglycol diacrylate, polyethyleneglycol dimethacrylate, polypropyleneglycol diacrylate, polypropyleneglycol dimethacrylate, trimethylolpropanetriacrylate, trimethylolpropanetrimethacrylate, ethoxylated trimethylolpropanetriacrylate, ethoxylated trimethylolpropanetrimethacrylate, pentaerythritol triacrylate, pentaerythritol trimethacrylate, pentaerythritol tetraacrylate, pentaerythritol tetramethacrylate, and combinations thereof. Other examples of suitable acrylates include acrylamides and methacrylamides such as N-isopropyl acrylamide and N,N-dimethylacrylamide. Suitable examples of alkenoates include, but are not limited to, alkyl-N-alkenoates, methyl-3-butenoate, and combinations thereof. In one embodiment, the radical polymerizable compound is selected from the group of alkylene glycol dialkylacrylate, alkylene glycol diacrylate, and combinations thereof.

The compound having at least one C═C bond may also include styrene and substituted styrenes, particularly when used in conjunction with acrylic monomers. Styrenes may be represented by the general formula:

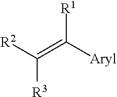

wherein Aryl is phenyl, or derivatives thereof, and R¹, R², R³ are each independently any alkyl group having 1 to 20 carbon atoms, e.g. any described in this disclosure. For example, the alkyl group may have 1, 2, 3, 4, 5, 6, 7, 8, 9, 10, 11, 12, 13, 14, 15, 16, 17, 18, 19, or 20, carbon atoms or any range thereof.

It is also contemplated that the compound having at least one C═C bond may include compounds including acryloxyalkyl groups such as an acryloxypropyl group, methacryloxyalkyl groups such as a methacryloxypropyl group, and/or unsaturated organic groups including, but not limited to, alkenyl groups having 2-12 carbon atoms including vinyl, allyl, butenyl, and hexenyl groups, alkynyl groups having 2-12 carbon atoms including ethynyl, propynyl, and butynyl groups, and combinations thereof. The unsaturated organic groups may include radical polymerizable groups in oligomeric and/or polymeric polyethers including an allyloxypoly(oxyalkylene) group, halogen substituted analogs thereof, and combinations thereof.

It is also contemplated that mixtures of monomers, dimers, oligomers, pre-polymers, polymers, co-polymers, and/or macromonomers may be used. In various embodiments, the compound having at least one C═C bond typically has from 1 to 20 and more typically has from 1 to 10, carbon atoms. In various embodiments, this compound includes acrylate functional groups such as acryloxyalkyl groups, methacrylate functional groups such as methacryloxyalkyl groups, cyanofunctional groups, and monovalent hydrocarbon groups, and combinations thereof. The monovalent hydrocarbon groups may include alkyl groups such as methyl, ethyl, propyl, pentyl, octyl, undecyl, and octadecyl groups, cycloalkyl groups such as cyclohexyl groups, alkenyl groups such as vinyl, allyl, butenyl, and hexenyl groups, alkynyl groups such as ethynyl, propynyl, and butynyl groups, aryl groups such as phenyl, tolyl, xylyl, benzyl, and 2-phenylethyl groups, halogenated hydrocarbon groups such as 3,3,3-trifluoropropyl, 3-chloropropyl, dichlorophenyl, and 6,6,6,5,5,4,4,3,3-nonafluorohexyl groups, and combinations thereof. The cyano functional groups may include cyanoalkyl groups such as cyanoethyl and cyanopropyl groups. These groups may also include alkyloxypoly(oxyalkyene) groups such as propyloxy(polyoxyethylene), propyloxypoly(oxypropylene) and propyloxy-poly(oxypropylene)-co-poly(oxyethylene) groups, halogen substituted alkyloxypoly(oxyalkyene) groups such as perfluoropropyloxy(polyoxyethylene), perfluoropropyloxypoly(oxypropylene) and perfluoropropyloxy-poly(oxypropylene) copoly(oxyethylene) groups, alkenyloxypoly(oxyalkyene) groups such as allyloxypoly(oxyethylene), allyloxypoly(oxypropylene) and allyloxy-poly(oxypropylene) copoly(oxyethylene) groups, and combinations thereof.

In still other embodiments, the compound may be, or be chosen from, aliphatic epoxyacrylates, aliphatic urethane acrylate (e.g. in 30% solvent), 2+2 isocyanate and acrylate, urethane acrylate w 30% butylacetate, methyl acrylate (MA), hydroxypropyl methacrylate (HPMA), tetrahydroxyfurfurylmethacrylate, hydroxypropylacrylate (HPA), hydroxybutylacrylate (HBA), hydroxybutylmethacrylate (HBMA), hydroxyethylacrylate (HEA) hydroxyethylmethacrylate (HEMA), monohydroxypoly(meth)acrylate, methyl acrylate, acrylates such as hexanediol diacrylate (HDODA (di-functional)), trimethylopropane triacrylate (TMPTA (tri-functional)), vinylether: Diethyleneglycol vinyl ether (DEGVE), polyethylene (glycol) diacrylate (PEGDA), dodecyldivinylether (DDVE), lauryl acrylate, and combinations thereof. A single compound may be used or two or more compounds may be used. In various embodiments, the compound having at least one carbon-carbon double may be present in the composition in an amount of from 0.5 to 10, from 1.0 to 5, or from 1.5 to 3.0, parts by weight per 100 parts by weight of the composition. In other embodiments, the weight ratio of the compound having at least one carbon-carbon double bond and the polysulfide is from 0.5 to 10, from 1.0 to 5.0, or from 1.5 to 3.0.

### Compound Having at Least One C≡C Bond (Carbon-Carbon Triple Bond):

In various embodiments, the compound having at least one C═C bond may be replaced by, or may be utilized in addition to, a compound having a carbon-carbon triple bond. Compounds having a CC bond may be represented by the general formula:

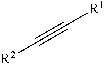

wherein R¹ and R² are each independently any alkyl group having 1 to 20 carbon atoms, e.g. any described in this disclosure. For example, the alkyl group may have 1, 2, 3, 4, 5, 6, 7, 8, 9, 10, 11, 12, 13, 14, 15, 16, 17, 18, 19, or 20, carbon atoms or any range thereof.

### Alkylborane Amine Catalyst:

The composition also includes the alkylborane amine catalyst. The alkylborane amine catalyst is typically described as a complex of an alkylborane compound and an amine compound. Said differently, a typical alkylborane amine catalyst includes a complex formed between an alkylborane and a suitable amine compound that renders the complex stable at ambient conditions (e.g. in air). The air-stable complex of alkylborane amine catalyst may function as a catalyst through decomplexation of the alkylborane compound from the amine compound.

Any alkylborane amine catalyst known in the art may be used. Typically, the alkylborane amine catalyst is capable of curing the polysulfide through introduction of an amine-reactive compound and/or by heating. That is, the alkylborane amine catalyst may be destabilized at ambient temperatures through exposure to suitable amine-reactive compounds. Heat may be applied if needed or desired. The alkylborane amine catalyst may have the formula:

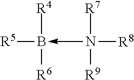

wherein B represents boron. Additionally, each of R⁴, R⁵, R⁶, R⁷, R⁸, and R⁹ is typically selected from the group of a hydrogen atom, a cycloalkyl group, a linear or branched alkyl group having from 1 to 12 carbon atoms in a backbone, an alkylaryl group, an organosilane group, an organosiloxane group, an alkylene group capable of functioning as a covalent bridge to the boron, a divalent organosiloxane group capable of functioning as a covalent bridge to the boron, and halogen substituted homologues thereof. Further, each of R⁷, R⁸, and R⁹ typically yields an amine compound or a polyamine compound capable of complexing the boron. In various non-limiting embodiments, two or more of R⁴, R⁵, and R⁶ and two or more of R⁷, R⁸, and R⁹ can combine to form heterocyclic structures, e.g. provided a sum of the number of atoms from R⁴, R⁵, R⁶, R⁷, R⁸, and R⁹ does not exceed 11.

In various embodiments, the alkylborane compound of the alkylborane amine catalyst includes a tri-functional borane which has the general structure:

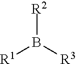

wherein each of R¹-R³ independently has from 1 to 20 carbon atoms and wherein each of R¹-R³ independently comprise one of an aliphatic hydrocarbon group or an aromatic hydrocarbon group. The aliphatic and/or aromatic hydrocarbon groups may be linear, branched, and/or cyclic. Suitable examples of the alkylborane include, but are not limited to, tri-methylborane, tri-ethylborane, diethyl borane, tri-n-butylborane, tri-n-octylborane, tri-sec-butylborane, tri-dodecylborane, phenyldiethylborane, and combinations thereof. In one embodiment, the alkylborane compound includes tri-n-butylborane. In various non-limiting embodiments, all values and ranges of values between the aforementioned values are hereby expressly contemplated.

Additionally, any amine known in the art may, in theory, be used to form the alkylborane amine catalyst. Typically, the amine includes at least one of an alkyl group, an alkoxy group, an alkylamino group, an imidazole group, an amidine group, an ureido group, and combinations thereof. Particularly suitable amines include, but are not limited to, 1,3-propane diamine, 1,6-hexanediamine, methoxypropylamine, pyridine, isophorone diamine, and combinations thereof.

In various embodiments, the alkylborane amine catalyst has one or more alkyl groups bonded to a boron atom and each of the one of more alkyl groups is independently further defined as a C₁-C₁₂ alkyl group, e.g. an alkyl group having 1, 2, 3, 4, 5, 6, 7, 8, 9, 10, 11, or 12, carbon atoms. The alkyl group may be linear, branched, cyclic, etc. and may be any known in the art having 1 to 12 carbon atoms. In other embodiments, the alkylborane amine catalyst has one more alkyl groups bonded to a nitrogen atom and each of the one of more alkyl groups is independently further defined as a C₁-C₁₂ alkyl group. Just as above, the alkyl group may have 1, 2, 3, 4, 5, 6, 7, 8, 9, 10, 11, or 12 carbon atoms and may be linear, branched, cyclic, etc. and may be any known in the art having 1 to 12 carbon atoms. The groups bonded to the boron atom may be the same or different than the groups bonded to the nitrogen atom. In various non-limiting embodiments, all values and ranges of values between the aforementioned values are hereby expressly contemplated.

The alkylborane amine catalyst may be used in any amount. Typically, the alkylborane amine catalyst is used in an amount equivalent to of from 0.1 to 10, 0.5 to 9, 1 to 7, 0.1 to 5, 1.5 to 5, 2 to 4, 0.5 to 4.5, 1 to 4, 1.5 to 3.5, 2 to 3, or 2.5 to 3, parts by weight per 100 parts by weight of the composition. In other embodiments, the alkylborane amine catalyst is used in an amount equivalent to of from 0.1 to 10, from 0.1 to 8, from 1 to 10, from 2 to 9, from 3 to 8, from 4 to 7, or from 5 to 6, parts by weight per 100 parts by weight of the composition.

The amounts of the alkylborane amine catalyst typically depend upon a molecular weight and functionality of the polysulfide and the presence of other components such as fillers. In various embodiments, the amount used is based on percent boron in the reaction mixture, calculated by the weight of the active ingredients (e.g. polysulfide(s)). In various non-limiting embodiments, all values and ranges of values between the aforementioned values are hereby expressly contemplated.

### Reactive Compound/Decomplexer:

In addition, a reactive compound (e.g. an amine reactive compound), such as a decomplexer, may also be utilized or may be omitted. For example, the alkylborane amine catalyst may interact with an amine-reactive compound to initiate or accelerate curing of the polysulfide. This may allow the polysulfide to cure at lower temperatures and/or with increased reaction rate and decreased cure times. Typically this occurs when the amine-reactive compound is mixed with the alkylborane amine catalyst and may be exposed to an oxygenated environment at temperatures below a dissociation temperature of the alkylborane amine catalyst, including room temperature and below. In terms of “activating” the alkylborane, oxygen is not necessarily required. However, an oxygen source is typically later required to create reactive radicals. It is contemplated that an excess of oxygen may quench the alkylborane to give unreactive products. Referring back, the amine-reactive compound may be or include any amine-reactive compound known in the art and can be delivered as a gas, liquid, or solid. In one embodiment, the amine-reactive compound includes free radical polymerizable groups or other functional groups such as a hydrolyzable group, and can be monomeric, dimeric, oligomeric or polymeric. In various embodiments, the alkylborane amine catalyst includes a trialkylborane amine catalyst. In other embodiments, the amine-reactive compound is chosen from acids, anhydrides, and combinations thereof.

In various embodiments, the amine-reactive compound is chosen from the group of an acid, an anhydride, and combinations thereof. In other embodiment, the amine-reactive compound includes amine-reactive groups, such as amine-reactive groups. It is contemplated that the amine-reactive groups may be derived from the alkylborane amine catalyst and/or any additives present. The amine-reactive compound may be selected from the group of Lewis acids, carboxylic acids, carboxylic acid derivatives, carboxylic acid salts, isocyanates, aldehydes, esters, epoxides, acid chlorides, sulphonyl chlorides, iodonium salts, anhydrides, and combinations thereof. In one embodiment, the amine-reactive compound is selected from the group of isophorone diisocyanate, hexamethylenediisocyanate, toluenediisocyanate, methyldiphenyldiisocyanate, acrylic acid, methacrylic acid, 2-hydroxyethylacrylate, 2-hydroxymethylacrylate, 2-hydroxypropylacrylate, 2-hydroxypropylmethacrylate, methacrylic anhydride, undecylenic acid, citraconic anhydride, polyacrylic acid, polymethacrylic acid, and combinations thereof. In yet another embodiment, the amine-reactive compound is selected from the group of oleic acid, undecylenic acid, polymethacrylic acid, acrylic acid, stearic acid, citric acid, levulinic acid, and 2-carboxyethyl acrylate, and combinations thereof. In another embodiment, the amine-reactive compound may include, but is not limited to, acetic acid, acrylic acid, methacrylic acid, methacrylic anhydride, undecylenic acid, oleic acid, an isophorone diisocyanate monomer or oligomer, a hexamethylenediisocyanate monomer, oligomer, or polymer, a toluenediisocyanate monomer, oligomer, or polymer, a methyldiphenyldiisocyanate monomer, oligomer, or polymer, methacryloylisocyanate, 2-(methacryloyloxy)ethyl acetoacetate, undecylenic aldehyde, dodecyl succinic anhydride, compounds capable of generating amine-reactive groups when exposed to ultraviolet radiation such as photoacid generators and iodonium salts including [SbF6]-counter ions. With such ultraviolet photoacid generators, a photosensitizing compound such as isopropylthioxanthone may be included.

The decomplexer/amine-reactive compound may be used in an amount of 0.1 to 5, 0.5 to 4.5, 1 to 4, 1.5 to 3.5, 2 to 3, 2.5 to 3, from 0.1 to 10, from 0.1 to 8, from 1 to 10, from 2 to 9, from 3 to 8, from 4 to 7, or from 5 to 6, parts by weight per 100 parts by weight of the composition. In various non-limiting embodiments, all values and ranges of values between the aforementioned values are hereby expressly contemplated. The amount of the amine-reactive compound may depend upon a molecular weight and functionality of the amine-reactive compound and the presence of other components such as fillers. In another embodiment, the amine-reactive compound is typically used in an amount wherein a molar ratio of amine-reactive groups to nitrogen groups in the alkylborane amine catalyst is of from 0.1:100, more typically from 0.5:50, and most typically from 0.8:20. In various non-limiting embodiments, all values and ranges of values between the aforementioned values are hereby expressly contemplated.

In various embodiments, the composition and/or sealant (during or after curing) includes a weight percent of boron that is approximately equimolar to an amount of boron initially present in the curable sealant composition within 10 mol %, e.g. ±1, 2, 3, 4, 5, 6, 7, 8, 9, or 10, mol %. For example, the amount of boron present in the composition and/or sealant either during or after cure is typically the same as the amount of boron initially added to the composition as part of the alkylborane amine catalyst. This amount is typically measured or reported as mole percent for the sake of accuracy. The amount of boron present during or after cure is typically within 10 mol percent of the amount of boron added at the beginning, e.g. the amount of boron added as part of the alkylborane amine catalyst. In various non-limiting embodiments, all values and ranges of values between the aforementioned values are hereby expressly contemplated.

### Metal Oxide Catalyst

The composition may also include an optional metal oxide catalyst. The metal oxide catalyst may be treated (e.g. with sodium hydroxide) or untreated. The metal oxide catalyst may be chosen from manganese dioxide (MnO₂), lead dioxide (PbO₂), lead oxide (PbO), cadmium oxide (CdO), zinc oxide (ZnO), and combinations thereof. In still other embodiments, the metal catalyst may be chosen from dioxides of lead, manganese, calcium, barium, sodium and zinc, and combinations thereof. In one embodiment, the metal oxide catalyst is manganese dioxide, also known as Manganese (IV) oxide. Other manganese oxides can also be used such as Manganese (II), Manganese (III), Manganese (V), and Manganese (VII), oxides, or combinations thereof. In a further embodiment, a combination of BaO and CaO are used. PbO may also be optionally used.

The amount of the metal oxide catalyst in the composition is not particularly limited. In various embodiments, the metal oxide catalyst is present in the composition in an amount of from 1 to 30, from 1 to 20, or from 1 to 10, parts by weight per 100 parts by weight of the composition. In various non-limiting embodiments, all values and ranges of values between the aforementioned values are hereby expressly contemplated.

### Cure Accelerator:

The composition may also include, or be free of, a cure accelerator. The cure accelerator may be any known in the art. For example, the cure accelerator may be a basic amine. In other embodiments, the cure accelerator is an aminic curing accelerator. In still other embodiments, the cure accelerator is chosen from tertiary amines, such as 1,4-diazabicyclo[2,2,2]octane (DABCO or TEDA), 1,8-diazabicyclo[5,4,0]undec-7-ene (DBU), 1,5-diazabicyclo[4,3,0]non-5-ene (DBN), N,N,N′,N″,N″-pentamethyldiethylenetriamine (PMDETA), N-methyl-N′-(dimethylaminoethyl)piperazine, N,N-dimethylcyclohexylamine (DMCHA), N,N′,N″-tris(dimethylaminopropyl)hexahydrotriazine or bis(2-(dimethylamino)ethyl)ether (BDMAEE), guanidine and derivatives thereof, such as diphenylguanidine, tetramethylguanidine or di-o-tolylguanidine, morpholine and derivatives thereof, such as N-methylmorpholine (NMM), N-ethylmorpholine (NEM), dimorpholinodiethyl ether (DMDEE), or N-methylmorpholine oxide (NMMO), Lewis acids, such as FeCl₃, AlCl₃ or SnCl₂, and tin salts, such as dibutyl tin dilaurate (DBTDL) or dioctyl tin dilaurate (DOTDL), and combinations thereof. In other embodiments, the cure accelerator may be chosen from guanidines, bis(piperidinothiocarbonyl) tetrasulphide, and strong N bases (as would be understood in the art), and combinations thereof. In still further embodiments, the cure accelerator may be chosen from tertiary amines, and more particularly 1,4-diazabicyclo[2,2,2]octane (DABCO or TEDA) and 1,8-diazabicyclo[5,4,0]undec-7-ene (DBU), and combinations thereof.

In further embodiments, the cure accelerator is an amine or thiuram curing accelerator. In various embodiments, the thiuram curing accelerator has the structure:

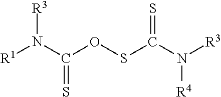

wherein each of R¹, R², R³, and R⁴, is any alkyl group having 1 to 20 carbon atoms, e.g. any described in this disclosure. In other embodiments, the thiuram curing accelerator has the structure:

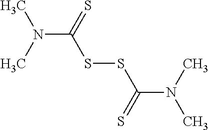

The amount of the cure accelerator that may be used is not particularly limited and may be chosen by one of skill in the art. In various embodiments, the cure accelerator is present in an amount of from 0.1 to 10, from 0.5 to 10, from 1 to 10, from 0.1 to 1, from 0.5 to 1, from 1 to 5, or from 5 to 10, parts by weight per 100 parts of polysulfide. In various non-limiting embodiments, all values and ranges of values between the aforementioned values are hereby expressly contemplated.

### Additives:

The composition may also include one or more additives or be free of any one or more additives, such as those described below. For example, in various embodiments, the composition includes a plasticizer such as, but not limited to, aliphatic oils, waxes, fatty acid salts, resins derived from alkylated phenols and esters, and combinations thereof. In other embodiments, the composition includes one or more fillers such as, but not limited to, microspheres, polystyrene foam, polyacrylates, polyolefins, silica, aluminum/silica, aluminum silicate, calcium carbonate, coated polyvinylidene, calcium silicates, fumed silica, precipitated silica, polyethylene, Calcium carbonate, carbon black, calcined clay, talc, silica, silicate fillers, rutile titanium dioxide, zeolites, and combinations thereof. In still other embodiments, the composition includes one or more adhesion promoters such as, but not limited to, methylon AP-108, Duerz 16674, Bakelite BRL 3741, Resinex 468, silanes, phenolic resins, polysulfides, epoxy functional molecules, and combinations thereof. In further embodiments, the composition includes surfactants, such as those known in the art, thixotropic agents such as sepiolite and those known in the art, solvents such as organic solvents, ethyl acetate, terphenyls, hydrogenated terphenyls, toluene, and those known in the art, and/or pigments such as titanium dioxide, zinc sulfide, carbon black, organic and inorganic pigments, and those known in the art, and combinations thereof. In further embodiments, the composition includes photosensitizers and/or photo initiators, or combinations thereof. Moreover, the composition may be free of any one or more such additives.

In still other embodiments, the composition may include or be free of one or more of calcium carbonate, butanone, toluene, titanium dioxide, Ethanethiol, 2,2,-thiobis-1 reaction products with reduced 1,1′-[methylenebis(oxy)]bis [2-chloroethane]-sodium sulfide (Na2 (Sx)-1,2,3-trichloropropane polymer, ethyl acetate, hydrogenated Terphenyls, Zeolites, quater- and higher, partially hydrogenated Polyphenyls, Talc, carbon black, magnesium carbonate, 1,3-diphenylguanidine, bis(piperidinothiocarbonyl) tetrasulphide, photoinitiators, photosensitizers such as benzophenone, isopropyl thioxanthone, aluminum silicate, phenolic resins, Sepiolite, NaAl-based zeolite, phosphorous acid esters, monomeric isocyanates, e.g. based on MDI, pyrogenic silica, and/or combinations thereof.

In still further embodiments, mixtures of photosensitizers and/or photoinitiators may be used to adjust the absorption wavelength(s) of the composition or to shift the absorption edge and/or the absorption range of the composition. Further, fillers based on magnesium silicate hydrate such as, for example, talc, based on aluminum hydroxide such as, for example, Al(OH)₃, based on a feldspar, based on quartz powder and/or based on a calcium silicate and/or aluminum silicate may be used and may have a particle size from 1 to 20 micrometers. Adding one or more fillers may serve to improve the mechanical properties of the composition. In various embodiments, the fillers are chosen from calcium silicate, magnesium silicate hydrate, aluminum silicate, quartz powder and/or aluminum hydroxide such as, for example, aluminum trihydrate. Fillers based on CaCO₃, TiO₂, carbon black and/or BaSO₄ as well as fillers with a significant Fe content and/or containing additional heavy metals may be used.

Lightweight fillers, in particular those based on polyurethane including their copolymers, polyamide wax and/or polyolefin wax may also be used. Lightweight fillers may also be used to reduce the density of the composition and/or sealant. Alternatively or additionally, hollow filing bodies may also be used.

Thixotropy agents, in particular based on feldspar, silicic acid/silica, sepiolite and/or bentonite may be used to adjust rheological properties, in particular for thixotropic behavior, of the composition.

Plasticizers, in particular based on an adipate, a benzoate, a citrate, a phthalate, an ester of a polyethylene glycol, and/or a terphenyl may be used, for example, to increase the flexibility of the composition and/or sealant.

Adhesion promoters, in particular those based on a phenolic resin, a resol and/or a silane/silanol/siloxane, e.g. mercaptopropyltrimethoxysilane, mercaptopropyltriethoxysilane, glycidoxypropyltrimethoxysilane, glycidoxypropyltriethoxysilane, methacryloxymethyltrimethoxysilane and/or (methacryloxymethyl)methyldimethoxysilane and/or a bis-silylsilane may be used to improve the adhesion of the composition and/or sealant to a substrate.

Anti-aging agents may also be used such as sterically hindered phenols, phenyleneamine and/or hindered amine light stabilizers such as 4,6-bis(dodecylthiomethyl)-o-cresol, ethylene-bis(oxyethylene)bis(3-(5-tert-butyl-4-hydroxy-m-tolyl)propionate-, thiodiethylene-bis[3-(3,5-di-tert-butyl-4-hydroxyphenyl)propionate], pentaerythritol tetrakis(3-(3,5-di-tert-butyl-4-hydroxyphenyl)-propionate) and/or phenylene amines such as, for example, N-isopropyl-N′-phenyl-p-phenylenediamine. Anti-aging agents may be used to scavenge the free radicals formed due to aging processes involving the composition and may contribute to delaying and/or preventing aging such as yellowing or embrittlement of the composition and/or sealant.

Water scavengers, e.g. those based on an organofunctional alkoxysilane, based on a zeolite such as an alkali aluminum zeolite and/or based on a monofunctional isocyanate may also be used.

Flame retardants, in particular those based on phosphate esters, based on ammonium polyphosphate, based on melamine, based on aluminum hydroxide and/or based on magnesium hydroxide may also be used to improve the fire prevention behavior of the composition and/or sealant such as, for example, to delay the onset of burning of the sealant, to spontaneously terminate the burning process and/or to reduce the formation of smoke.

Vulcanization promoters may also be used such as diphenylguanidine, thiuram, and/or sulfur (e.g. sulfur paste).

In various embodiments, at least one organic solvent, in particular based on an ester and/or an ether such as, for example, ethyl acetate and/or monopropylene glycol monomethyl ether can be used.

The one or more additives may be present in an amount of from 0 to 20, 0.1 to 10, from 0.1 to 5, or from 0.1 to 2, parts by weight per 100 parts by weight of the composition. In various non-limiting embodiments, all values and ranges of values between the aforementioned values are hereby expressly contemplated.

In still other embodiments, the composition includes an acid or is free of an acid. If included, the acid is typically acetic acid, acrylic acid, isostearine acid, and combinations thereof. Also, if included, the acid is included in an amount of from 0.1 to 3, from 0.1 to 2, from 0.1 to 1, or from 0.25 to 0.75, parts by weight per 100 parts by weight of the composition. In various non-limiting embodiments, all values and ranges of values between the aforementioned values are hereby expressly contemplated.

### Sealant System:

This disclosure also provides a sealant system. In one embodiment, this system includes a first component including, consisting essentially of, or consisting of, the polysulfide and the alkylborane amine catalyst, and a second component including, consisting essentially of, or consisting of, the compound having the at least one carbon-carbon double bond. In another embodiment, this system includes a first component including, consisting essentially of, or consisting of, the polysulfide and a first portion of the alkylborane amine catalyst, and a second component including, consisting essentially of, or consisting of, the compound having the at least one carbon-carbon double bond and a second portion of the alkylborane amine catalyst. In still other embodiments, the system includes a first component including, consisting essentially of, or consisting of, the polysulfide and a second component including, consisting essentially of, or consisting of, the compound having the at least one carbon-carbon double bond and the alkylborane amine catalyst. Moreover, one or more additives or any other components described above may be present in one or both components. The terminology “consisting essentially of” describes that the first and/or second component is free of other polymers, monomers, catalysts, etc. In various embodiments, the first component and the second component are utilized in an amount of 1:1, 2:1, 3:1, 4:1, 5:1, 6:1, 7:1, 8:1, 9:1, or 10:1, or vice versa. In various non-limiting embodiments, all values and ranges of values between the aforementioned values are hereby expressly contemplated.

### Sealant:

The disclosure also provides a sealant, which may be described as the result of the composition after cure. Alternatively, the sealant may be described as a partially cured composition.

The composition cures typically using a mechanism based on the alkylborane amine catalyst to form the sealant. Moreover, a dual-cure mechanism may be utilized if the metal oxide catalyst is used. Each of these mechanisms is generally known in the art. The sealant may be described as the polymerization product of the polysulfide and the compound having the at least one carbon-carbon double bond reacted in the presence of the organoborane amine catalyst (and optionally the metal oxide catalyst). Alternatively, the sealant may include, consist essentially of, or consist of, such a polymerization product. The terminology “consist essentially of” describes embodiments that are free of polymers or co-polymers, of any known in the art, that are not the sealant itself, i.e., the polymerization product of the polysulfide and the compound having the at least one carbon-carbon double bond reacted in the presence of the organoborane amine catalyst (and optionally the metal oxide catalyst).

In various embodiments, the composition cures to have a viscosity of greater than 1,000, 1,500, 2,000, 2,500, or 3,000 cps in 15, 10, or 5 minutes. Typically, a maximum viscosity in 15, 10, or 5 minutes is greater than 1000 cps as measured using a viscometer such as a Brookfield DV-II+ Pro with an appropriate spindle such as a #RV7 spindle. The maximum viscosities in these times may be 10,000, 50,000, 100,000, 500,000, 1,000,000, 1,500,000, etc. up to about 350,000,000, cps, measured in the same way. In various non-limiting embodiments, all values and ranges of values between the aforementioned values are hereby expressly contemplated.

In various embodiments, the composition cures to a tack-free time of from 0.05 to 5 minutes after the start of cure according to DIN 65262-1. In other embodiments, the composition cures to a tack-free time of less than 120, 115, 110, 105, 100, 96, 90, 85, 80, 75, 70, 65, 60, 55, 50, 45, 40, 35, 30, 25, 20, 15, 10, or 5, minutes, after the start of cure according to DIN 65262-1. In other embodiments, the sealant has a complete curing time or the time until reaching a Shore hardness of 30, determined according to ISO 7619 or ASTM D2240, from 1 to 960 min, of from 5 to 300 min, of from 10 to 60 min. In additional embodiments, one or more portions of the sealant composition, e.g. the first and second components, may have a density, determined according to ISO 2781, of from 0.9 to 1.6 g/cm³ or from 1.2 to 1.5 g/cm³. In various non-limiting embodiments, all values and ranges of values between the aforementioned values are hereby expressly contemplated.

In other embodiments, the sealant has a Shore A hardness, determined according to ISO 7619 and measured 2 weeks after cure in storage in air at 23° C. and 50% relative atmospheric humidity, of from 20 to 80, of from 30 to 60, or of from 40 to 55. In additional embodiments, the sealant has a Shore A hardness of at least 10 within 30 to 180 minutes of curing. In further embodiments, the sealant has an elongation at break, determined according to ISO 37 and measured 2 weeks after cure during storage in air at 23° C. and 50% relative atmospheric humidity, of from 100 to 1000%, of from 200% to 800% or from 300% to 600%. In various non-limiting embodiments, all values and ranges of values between the aforementioned values are hereby expressly contemplated.

In other embodiments, the sealant has an elongation, determined according to ISO 37 and measured after 168 hours in storage in a fuel at 60° C., using the jet Al type of fuel, is of from 100 to 800%, of from 200 to 600% or of from 300 to 500%. In other embodiments, the sealant has an elongation at break of the sealants according to the invention, determined according to ISO 37 and measured after 300 hours in storage in fuel at 100° C., using the jet Al type of fuel is preferably of from 100 to 700%, especially preferably of from 200 to 600% or 400 to 500%. In even further embodiments, the sealant has an elongation at break, determined according to ISO 37 and measured after 1000 hours in storage in water at 35° C., of from 100 to 700%, e.g. from 200 to 500% or 250 to 350%. In various non-limiting embodiments, all values and ranges of values between the aforementioned values are hereby expressly contemplated.

In other embodiments, the sealant has a peel resistance on aluminum alloy 2024 T3, determined according to DIN 65262-1, of from 60 to 350 N/25 mm, e.g. from 100 to 250 N/25 mm or 160 to 200 N/25 mm. Alternatively, the sealant has a peel resistance on enamels, such as, for example, on base enamels including solvent such as, for example, epoxy base enamel 37035 A from Akzo Nobel Aerospace Coatings, on water-based base enamels such as, for example, those based on epoxy such as Seevenax 313-01 and Seevenax 313-02 from Mankiewicz, on cover enamels such as, for example, water-based top coats based on epoxies such as Seevenax 313-01 from Mankiewicz, on finish F 70-A from Mapaero and/or on solvent-containing top coats based on polyurethanes such as Aerodur 21-100 from Akzo Nobel and Alexit 406-22 from Mankiewicz, determined according to DIN 65262-1, of from 50 to 350 N/25 mm, e.g. from 10 to 300 N/25 mm or from 170 to 210 N/25 mm. In various embodiments, the peel resistance is determined on substrates of aluminum or aluminum alloys, of titanium or titanium alloys, of stainless steels, of composite materials such as, for example, carbon fiber-reinforced plastic CFP and/or on enamel substrates that have been enameled, for example, with at least one solvent-containing or water-based base coat and/or top coat, in particular based on epoxy, polyester or polyurethane enamel. In various non-limiting embodiments, all values and ranges of values between the aforementioned values are hereby expressly contemplated.

In additional embodiments, the sealant has a tensile strength, determined according to ISO 37 and measured after 2 weeks after UV irradiation with storage in air at 23° C. and 50% relative atmospheric humidity, of from 0.5 to 3.5 MPa, e.g. from 1 to 3 MPa or 1.8 to 2.7 MPa. In other embodiments, the sealant has a tensile strength, determined according to ISO 37 and measured after 168 hours at 60° C. in storage in fuel of jet Al type, is of from 0.5 to 3 MPa, e.g. of from 1 to 2.5 or 1.5 to 2 MPa. In further embodiments, the sealant has a tensile strength, determined according to ISO 37 and measured after 300 hours at 100° C. in storage in fuel of jet Al type, of from 0.5 to 3 MPa, e.g. from 1 to 2 or 0.8 to 1.1 MPa. In further embodiments, the sealant has a tensile strength, determined according to ISO 37 and measured after 1000 hours at 35° C. in storage in water, of from 0.5 to 3 MPa, e.g. of from 1 to 2 MPa or 1.5 to 1.7 MPa. In various non-limiting embodiments, all values and ranges of values between the aforementioned values are hereby expressly contemplated.

In still other embodiments, the sealant exhibits no cracks or other defects that occur in determination of low temperature flexibility due to bending at an angle of 30 degrees at a temperature of −55° C., a tensile strength of from 0.5 to 2.8 MPa after 168 hours of storage in a fuel at a temperature of 60° C., after 300 hours of storage in a fuel at a temperature of 100° C., and after 1000 hours of storage in water at a temperature of 35° C., an elongation at break of from 100 to 800% after 168 hours of storage in fuel at a temperature of 60° C., after 300 hours of storage in a fuel at a temperature of 100° C., and after 1000 hours of storage in water at a temperature of 35° C. and/or a density of from 1.00 to 1.45 g/cm³. In still other embodiments, the sealant as the following properties after complete curing: a tensile strength of from 0.5 to 3 MPa, an elongation at break of from 100 to 900% and/or a peel resistance of from 50 to 300 N/25 mm. In various non-limiting embodiments, all values and ranges of values between the aforementioned values are hereby expressly contemplated.

### Article:

This disclosure also provides an article that includes a substrate and the composition and/or (cured or partially cured) sealant disposed thereon. The article may be one used in the aviation industry, but may also be used wherever a rapid and complete curing and especially a very rapid surface curing with a relatively long sealant processing time are necessary and/or advantageous. For example, the article may be a tank or area to be sealed. In various embodiments, the composition and/or sealant may be used for plastering as in gas stations and chemical installations, for example, for connecting structural elements placed on top of one another such as sheet metal, films and other substrates, for filling cavities and intermediate spaces, for coating metallic materials in particular and composites such as, for example, carbon fiber reinforced or glass fiber reinforced plastics, for aerodynamic smoothing and compaction as well as for preventing corrosion in locations where the anticorrosion layers of the metallic elements have been damaged or removed, for example, in the area of boreholes. A load-bearing function may also be fulfilled, for example, during shipping. In various embodiments, the article is used in the shipping industry such as, for example, in automotive engineering, in the construction of rail vehicles, in shipbuilding, in the airplane construction industry or in the spacecraft construction industry, in machine and equipment construction, in the building industry or for the production of furniture. In one embodiment, the article is an aircraft fuel tank. In another embodiment, the article is further defined as a construction article, aircraft/aerospace article, motor or rail vehicle, ship, machine, glass insulation, and/or furniture. In still another embodiment, the article is further defined as glass insulation.

### Methods:

This disclosure also provides a method of forming the curable sealant composition wherein the method includes the steps of providing the polysulfide, the alkylborane amine catalyst, and the compound having the at least one carbon-carbon double bond, and combining the polysulfide, the alkylborane amine catalyst, and the compound having the at least one carbon-carbon double bond to form the curable composition.

This disclosure also provides a method of forming the cured sealant including the polymerization product of the polysulfide and the compound having the at least one carbon-carbon double bond reacted in the presence of the alkylborane amine catalyst. The method includes the steps of providing the polysulfide, the alkylborane amine catalyst, and the compound having the at least one carbon-carbon double bond; and combining the polysulfide, the alkylborane amine catalyst, and the compound having the at least one carbon-carbon double bond such that the polysulfide polymerizes with the compound having the at least one carbon-carbon double bond in the presence of the alkylborane amine catalyst to form the cured sealant. The method may also include use of the metal oxide catalyst in any one or more steps above or in independent steps.

This disclosure also provides a method of forming an article including the substrate and the cured sealant disposed thereon, wherein the cured sealant includes the reaction product of the polysulfide and the compound having the at least one carbon-carbon double bond reacted in the presence of the alkylborane amine catalyst. The method includes the steps of providing the polysulfide, the alkylborane amine catalyst, and the compound having the at least one carbon-carbon double bond; and applying the polysulfide, the alkylborane amine catalyst, and the compound having the at least one carbon-carbon double bond onto the substrate such that the polysulfide polymerizes with the compound having the at least one carbon-carbon double bond in the presence of the alkylborane amine catalyst and forms the cured sealant disposed on the substrate. The method may also include use of the metal oxide catalyst in any one or more steps above or in independent steps.

In the aforementioned methods, each step of providing may be any known in the art. Similarly, any step of combining may be any known in the art such that any one or more of the aforementioned components may be combined in any order and as a whole or in parts. Moreover, the step of applying may be further defined as dipping, pouring, spraying, brushing, or any other method of application known in the art.

### Reaction Product:

The curable composition may cure via polymerization or reaction of the polysulfide and the compound having the at least one carbon-carbon double bond. In other words, the polysulfide may react with the compound via a free-radical reaction or via a free-radical reaction and a metal oxide catalyzed reaction to form the cured composition. The reactions may occur by any method or mechanism that would be appreciated by one of skill in the art relative to free-radical and metal oxide chemistry.

### Examples

The compositions of Part A set forth in the matrix below are prepared by first mixing polysulfide polymers such as Thiokol LP 12, Thiokol LP2 and others, alkylborane-amine complexes such as triethylborane-1,3-diaminopropane complex (TEB-DAP), tri-n-butylborane-3-methoxy-1-aminopropane complex (TnBB-MOPA), plasticizers such as Benzoflex 88, fillers such as calcium carbonate, kaolin and others. TMPTA is Trimethylolpropane triacrylate which has at least one carbon-carbon double bond.

The compositions of Part B set forth in the matrix below are prepared by mixing manganese oxide with amine accelerators such as thiuram. In various embodiments, the compositions of Part B may be mixed with the compositions of Part A at a ratio of from about 15:1 to about 1:15, or any range of ratios therebetween, including the endpoints. In the examples below, the compositions of Part B are mixed with the compositions of Part A at a ratio of 1.2:10 manually or employing a speed mixer (FlackTek, speed-2500 rpm, time-one minute). The ratio of alkylborane amine complex is varied in the overall mixture. After mixing Parts A and B, touch tack free time is determined according to ASTM C679:

| | Example | Example | Example | Example | Example |
|---|---|---|---|---|---|
| | 1 | 2 | 3 | 4 | 5 |
| Long chain | 55.6 | 55.6 | 55.6 | 55.6 | 55.6 |
| polysulfide | | | | | |
| (4000 g/mol) | | | | | |
| Kaolin | 31.8 | 31.8 | 31.8 | 31.8 | 31.8 |
| Benzoflex 88 | 12 | 12 | 12 | 12 | 12 |
| TEB-DAP | 0 | 0.5 | 1.0 | 1.5 | 3.0 |
| TMPTA | 0 | 0.5 | 1.0 | 1.5 | 3.0 |
| Physical | | | | | |
| Properties | | | | | |
| Tack Free | none | 1440 | 1320 | 92 | 15 |
| Time (min) | | | | | |
| Shore A | <10 | <10 | <10 | 20 | 36 |
| Hardness | | | | | |
| After | | | | | |
| 24 h at RT | | | | | |

The results show polysulfides achieve tack free time using alkylborane amine complexes and molecules containing double bonds such as TMPTA. The curing of polysulfide with shore A hardness>30 can be further impacted by using alkylborane and molecules containing double bonds and small amounts of metal oxide such as MnO2.

Properties after mixing Part A with lower amounts of Part B and addition of TEB-DAP and TMPTA

| | Example 6 | Example 7 | Example 8 |
|---|---|---|---|
| Part A | | | |
| Long chain polysulfide | 55.5 | 55.5 | 55.5 |
| (4000 g/mol) | | | |
| Kaolin | 31.8 | 31.8 | 31.8 |
| Benzoflex 88 | 12 | 12 | 12 |
| Part B | | | |
| MnO₂ | 58 | 58 | 58 |
| Benzoflex 88 | 40.1 | 40.1 | 40.1 |
| Thiuram | 0.6 | 0.6 | 0.6 |
| Ratio part A:B | 9:0.5 | 9:0.25 | 9:0.1 |
| TEB-DAP | 1.5 | 1.5 | 1.5 |
| TMPTA | 1.5 | 1.5 | 1.5 |
| Guanidine | 0.7 | 0.7 | 0.7 |
| H₂O | 0.6 | 0.6 | 0.6 |
| Physical Properties | | | |
| Tack Free time (min) | 75 | 104 | 140 |
| Shore A hardness after | 38 | 42 | 36 |
| 24 h at RT | | | |

The results demonstrate that polysulfides can be consistently cured to shore A hardness>30 by using alkylborane amine complexes such as TEB-DAP and molecules containing a double bond such as TMPTA with significant lower amounts of metal oxide such as MnO₂ than traditional polysulfide sealants cured with metal oxides.

In various non-limiting embodiments, the instant disclosure may include or utilize one or more compounds, components, articles, method steps, etc. as described in the PCT application filed concurrently herewith and designated as BASF Docket Number: 160010-WO-01, which claims priority to U.S. Prov. App. Ser. No. 62/319,531.

All combinations of the aforementioned embodiments throughout the entire disclosure are hereby expressly contemplated in one or more non-limiting embodiments even if such a disclosure is not described verbatim in a single paragraph or section above. In other words, an expressly contemplated embodiment may include any one or more elements described above selected and combined from any portion of the disclosure.

One or more of the values described above may vary by ±5%, ±10%, ±15%, ±20%, ±25%, etc. Unexpected results may be obtained from each member of a Markush group independent from all other members. Each member may be relied upon individually and or in combination and provides adequate support for specific embodiments within the scope of the appended claims. The subject matter of all combinations of independent and dependent claims, both singly and multiply dependent, is herein expressly contemplated. The disclosure is illustrative including words of description rather than of limitation. Many modifications and variations of the present disclosure are possible in light of the above teachings, and the disclosure may be practiced otherwise than as specifically described herein.

It is also to be understood that any ranges and subranges relied upon in describing various embodiments of the present disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e. from 0.1 to 0.3, a middle third, i.e. from 0.4 to 0.6, and an upper third, i.e. from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

1. A curable sealant composition comprising:
A. a polysulfide having an —SH group;
B. a compound having at least one carbon-carbon double bond; and
C. an alkylborane amine catalyst; and
D. a metal oxide catalyst.

2. (canceled)

3. The curable sealant composition of claim 1 wherein said alkylborane amine catalyst has one or more alkyl groups bonded to a boron atom and each of said one of more alkyl groups is independently further defined as a C₁-C₁₂ alkyl group.

4. The curable sealant composition of claim 1 or 3 wherein said alkylborane amine catalyst has one more alkyl groups bonded to a nitrogen atom and each of said one of more alkyl groups is independently further defined as a C₁-C₁₂ alkyl group.

5. The curable sealant composition of any one of claim 1, 3, or 4 wherein said alkylborane amine catalyst is present in an amount of from 0.1 to 10 parts by weight per 100 parts by weight of said curable sealant composition.

6. The curable sealant composition of any one of claim 1 or 3-5 wherein said polysulfide has an —SH functionality of greater than or equal to 2.

7. The curable sealant composition of any one of claim 1 or 3-5 wherein said polysulfide has an —SH functionality of 0.8 to 2.

8. The curable sealant composition of any one of claim 1 or 3-7 wherein said polysulfide has a weight average molecular weight of from 1,000 to 7,500 g/mol.

9. The curable sealant composition of any one of claim 1 or 3-8 wherein said compound having at least one carbon-carbon double bond is an acrylate.

10. The curable sealant composition of any one of claim 1 or 3-9 wherein said metal oxide catalyst is manganese dioxide.

11. The curable sealant composition of any one of claim 1 or 3-10 further comprising an amine or thiuram curing accelerator.

12. The curable sealant composition of any one of claim 1 or 3-11 that cures to have a viscosity of greater than 1,000 cps in 15 minutes.

13. The curable sealant composition of any one of claim 1 or 3-12 that cures to a tack-free of less than 120 minutes after the start of cure according to DIN 65262-1.

14. The curable sealant composition of any one of claim 1 or 3-13 that is free of an acid.

15. The curable sealant composition of any one of claim 1 or 3-13 that further comprises an acid.

16. A cured sealant formed from the curable sealant composition of any one of claim 1 or 3-15 and comprising a weight percent of boron that is approximately equimolar to an amount of boron present in the curable sealant composition within 10 mol %.

17. The cured sealant of claim 16 comprising a weight percent of boron that is approximately equimolar to an amount of boron present during polymerization ±10% and has a Shore A hardness of at least 10 within 30 to 180 minutes of curing.

18. A method of forming a curable sealant composition comprising a polysulfide having an —SH group, a compound having at least one carbon-carbon double bond, an allylborane amine catalyst, and a metal oxide catalyst, said method comprising the steps of:
providing the polysulfide, the alkylborane amine catalyst, the compound having at least one carbon-carbon double bond, and the metal oxide catalyst, and
combining the polysulfide, the alkylborane amine catalyst, the compound having at least one carbon-carbon double bond, and the metal oxide catalyst to form the curable composition.

19. An article comprising a substrate and cured sealant disposed thereon, wherein said cured sealant comprises the reaction product of a polysulfide having an —SH group and a compound having at least one carbon-carbon double bond reacted in the presence of an alkylborane amine catalyst and a metal oxide catalyst.

20. The article of claim 19 wherein said cured sealant comprises a weight percent of boron that is approximately equimolar to an amount of boron present during reaction of the polysulfide within 10 mol %.

21. The article of claim 19 or 20 that is further defined as an aircraft fuel tank, a construction article, aircraft/aerospace article, motor or rail vehicle, ship, machine, glass insulation, and/or furniture.
